(19) United States
(12) Patent Application Publication
(10) Pub. No.: US 2010/0239736 A1
(43) Pub. Date: Sep. 23, 2010

(54) MULTI-EDGE BAKING PAN

(76) Inventors: Lou HENRY, Scarsdale, NY (US); James KWON, Brooklyn, NY (US)

Correspondence Address: AMSTER, ROTHSTEIN & EBENSTEIN LLP, 90 PARK AVENUE, NEW YORK, NY, 10016, US

(21) Appl. No.: 12/695,587

(22) Filed: Jan. 28, 2010

Related U.S. Application Data
(60) Provisional application No. 61/210,881, filed on Mar. 23, 2009.

(51) Int. Cl. A47J 37/01; A23P 1/00; A23L 1/01

(52) U.S. Cl. 426/523; 99/428

(57) ABSTRACT

The present invention is directed to a baking pan for baking brownies or other foods in which substantially each side of the baked good has a crisp edge, the pan comprising a bottom surface, a plurality of sidewalls comprising a plurality of sidewall segments, a plurality of towers joined to said bottom surface and rising therefrom and not touching any of the sidewalls, and a single baking cavity formed by the bottom surface, the plurality of sidewalls and the plurality of towers, wherein said towers and sidewalls define a plurality of baking compartments and a plurality of passages connecting said baking compartments. The present invention further relates to a method of baking brownies comprising providing the pan of the present invention, depositing a batter or food product into said baking cavity, baking the batter or food product, and forming a food item with crisp edges.

### CROSS-REFERENCE TO RELATED APPLICATIONS

This application claims priority to U.S. Provisional Patent Application No. 61/210,881, filed Mar. 23, 2009, the contents of which is herein incorporated by reference.

### FIELD OF THE INVENTION

The present invention relates to an improved pan for baking brownies or other food.

### SUMMARY OF THE INVENTION

One embodiment of the present invention comprises a baking pan comprising a bottom surface, a plurality of sidewalls comprising a plurality of sidewall segments, wherein each sidewall segment is set at an angle not equal to zero degrees to each adjacent segment, a plurality of towers joined to said bottom surface and rising therefrom and not touching any of the sidewalls, a single baking cavity formed by the bottom surface, the plurality of sidewalls and the plurality of towers, wherein said towers and sidewalls define a plurality of baking compartments and a plurality of passages connecting said baking compartments.

In at least one embodiment, the towers are substantially square in cross section.

In at least one embodiment, the towers and sidewalls are arranged such that food or batter placed in each baking compartment is in contact with a side of said tower or a sidewall segment on each side.

In at least one embodiment, the towers are substantially shaped like a parallelogram in cross section and said sidewall segments are substantially arcuate.

In at least one embodiment, the towers and sidewalls are inclined such that said baking compartments are generally frustoconical in shape.

Another embodiment of the present invention comprises a method of baking a food item or baked good, comprising (a) providing a baking pan comprising a bottom surface; a plurality of sidewalls comprising a plurality of sidewall segments, wherein each sidewall segment is set at an angle not equal to zero degrees to each adjacent segment; a plurality of towers joined to said bottom surface and rising therefrom and not touching any of the sidewalls; a single baking cavity formed by the bottom surface, the plurality of sidewalls and the plurality of towers, wherein said towers and sidewalls define a plurality of baking compartments and a plurality of passages connecting said baking compartments; (b) depositing a batter or food product into said baking cavity; (c) baking the batter or food product; and (d) forming a food item with crisp edges.

### BRIEF DESCRIPTION OF THE DRAWINGS

Exemplary embodiments of this invention will be described with reference to the accompanying figures.

FIG. 1 is a plan view of a baking pan according to an exemplary embodiment of the present invention.

FIG. 2 is a perspective view of a baking pan according to an exemplary embodiment of the present invention.

FIG. 3 is a plan view of a baking pan according to an exemplary embodiment of the present invention.

FIG. 4 is a side view of a baking pan according to an exemplary embodiment of the present invention.

FIG. 5 is a view of the finished product being removed form the baking pan of the present invention and being broken into individual baked goods.

FIG. 6 is a flowchart describing a method of use of a baking pan according to an embodiment of the present invention.

FIG. 7 is a plan view of a baking pan according to an embodiment of the present invention.

FIG. 8 is a perspective view of a baking pan according to an embodiment of the present invention.

FIG. 9 is a plan view of a baking pan according to an embodiment of the present invention.

FIG. 10 is a side view of a baking pan according to an embodiment of the present invention.

### DETAILED DESCRIPTION OF THE EXEMPLARY EMBODIMENTS

The present invention is directed to a single-pour baking pan for baking brownies or other foods in which substantially each side of the baked good has a crisp edge.

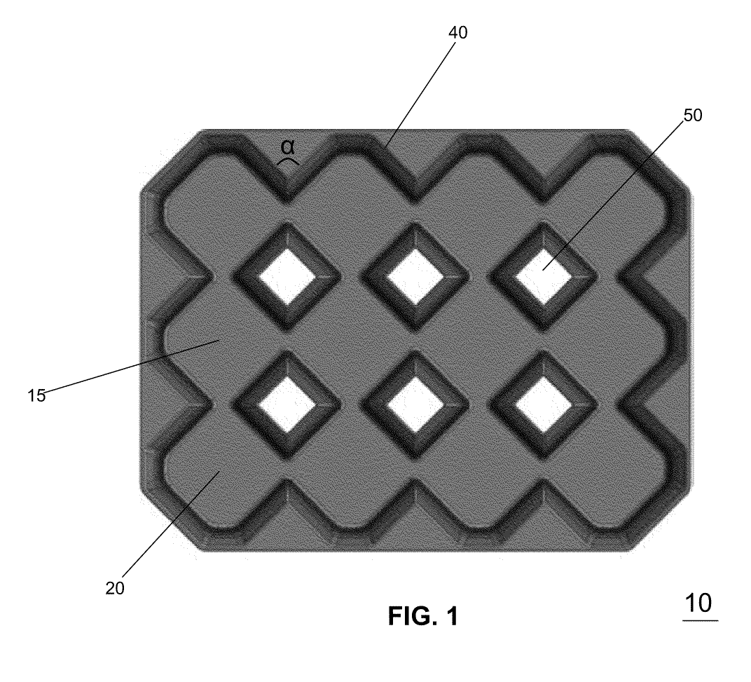

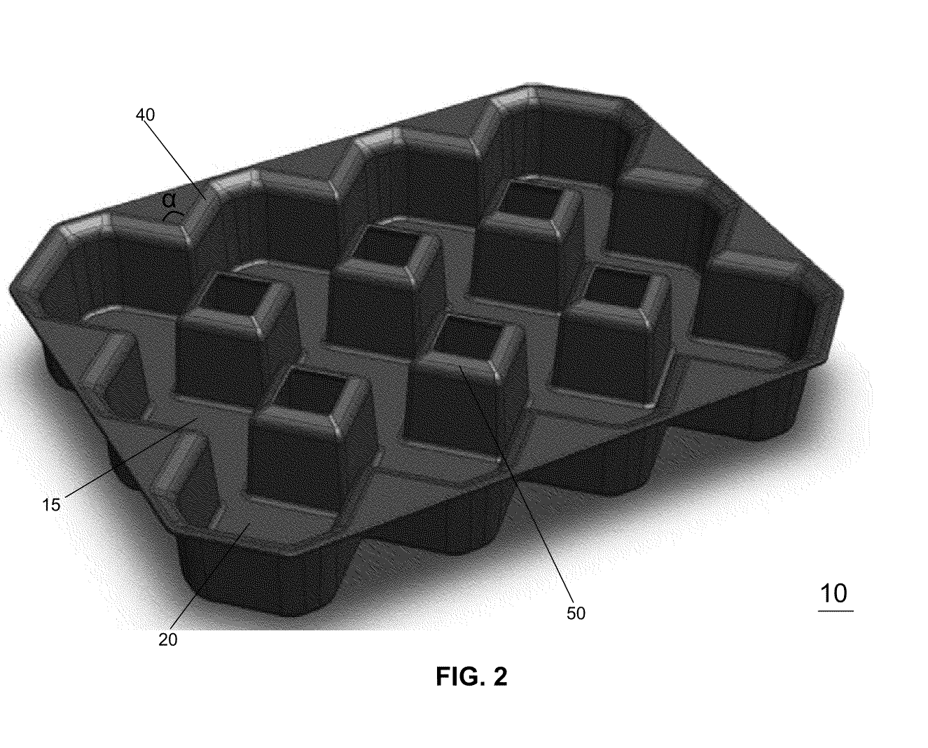

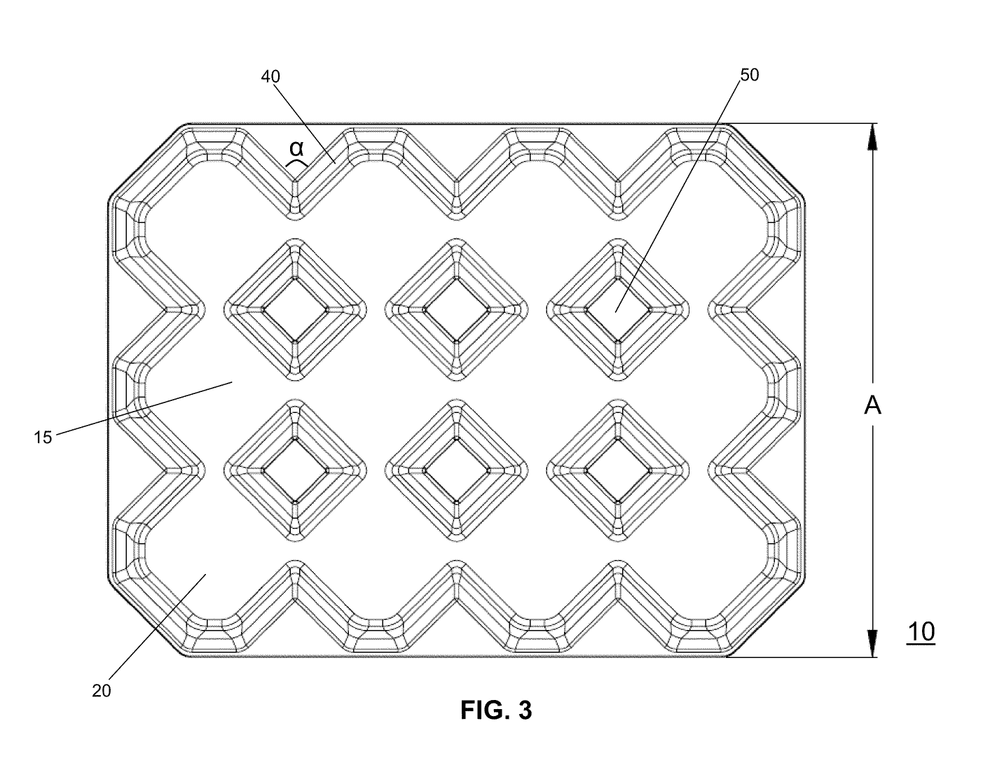

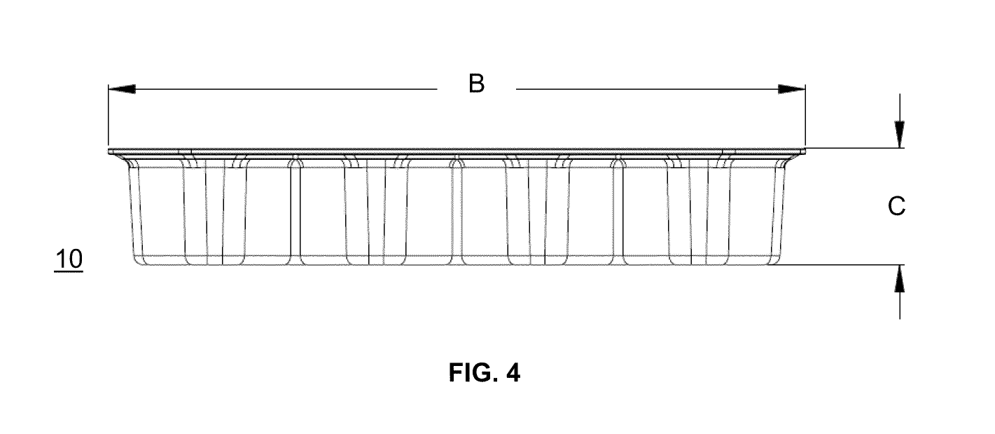

Referring to FIGS. 1-4, a baking pan 10 of an embodiment of the present invention is disclosed. Baking pan 10 comprises a single baking cavity 15 for receiving liquid batter that is formed by a bottom surface 20, a plurality of sidewalls 40, and a plurality of towers 50 rising from the bottom surface.

The towers 50 may be integrally formed with the bottom surface 20 of the baking pan 10. In embodiments, the towers 50 have four sides and an open top, although different numbers of sides (e.g., 1, 2, 3, 4, 5, 6, etc.) can be used without departing from the scope of the present invention. In embodiments, the towers 50 are detachable from the bottom surface 20 and can be rearranged in any pattern desired by the user.

In embodiments, the plurality of sidewalls 40 comprise a plurality of sidewall segments that are offset from one another at an angle α not equal to zero degrees. In embodiments, angle α is equal to 90 degrees, although other angles may be used (e.g., 70, 75, 80, 85, 95, 100, etc.).

The towers 50 and sidewalls 40 (including sidewall segments) define a series of passages through which liquid batter can flow prior to baking. The towers and sidewalls (including sidewall segments) further define a plurality of baking compartments, each of which will provide an individual baked good after baking. In the embodiment shown in FIGS. 1-4, the baking compartments are generally square in cross section, although other shapes may be provided (e.g., rectangles, triangles, ellipses, etc.).

To use, liquid batter or a food product is poured into the baking cavity 15. The passages formed by the towers and sidewalls allow for the batter to flow evenly into each baking compartment. The baking pan may then be placed in the oven and baked for the time called for by the recipe or manufacturer's instructions.

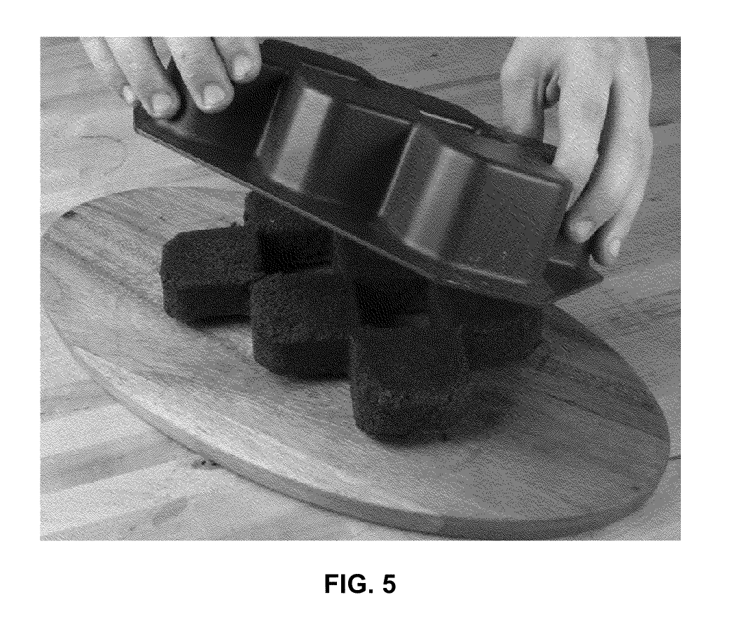

During baking, the liquid batter solidifies and batter in contact with a sidewall segment or tower forms a crispier texture than batter not in contact with a sidewall segment or tower. The batter that remained in the passages during baking can form a thin connector between adjacent pieces. As shown in FIG. 5, the finished baked good may be a single mass that can be removed from the pan and broken into pieces at the connector(s) adjacent to each piece. Each individual piece, having been baked adjacent to a plurality of towers and/or sidewall segments that impart additional heat to the batter, can have multiple crisp edges.

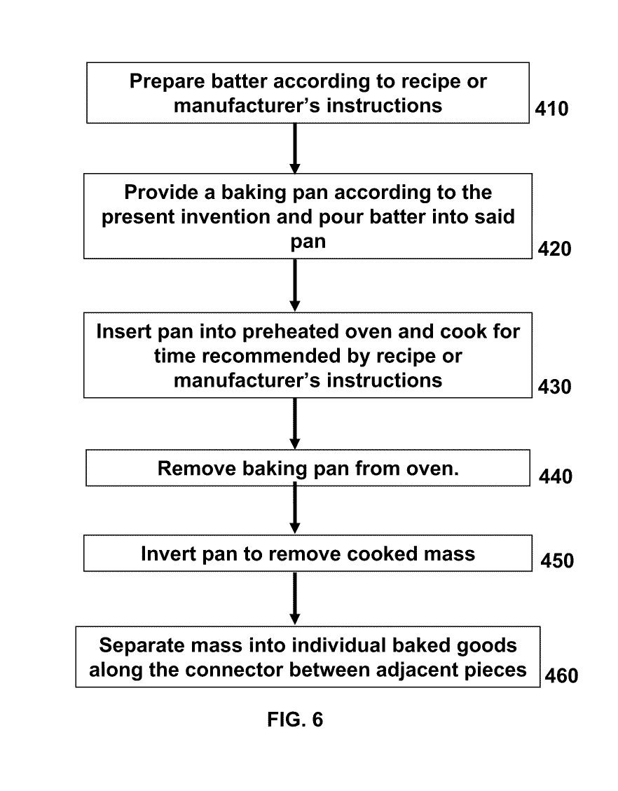

Referring to FIG. 6, a flowchart identifying the steps of using the baking pan of the present invention is disclosed. At step 410, the batter is prepared according to the recipe or, if used a prepared mix, according to the manufacturers instructions. A pan according to the present invention is then provided and the batter is poured into said baking pan and allowed to flow through the channels defined by the towers and sidewalls. At step 430, the filled baking pan is inserted into a preheated oven and baked for the time called for by the recipe or manufacturer's instructions. The baking pan is then removed from the oven and at step 450, the pan is inverted to remove the baked mass. At step 460, the mass is separated along the thin connectors between adjacent segments to form individual baked goods. Each individual piece, having been baked adjacent to a plurality of towers and/or sidewall segments that impart additional heat to the batter can have multiple crisp edges.

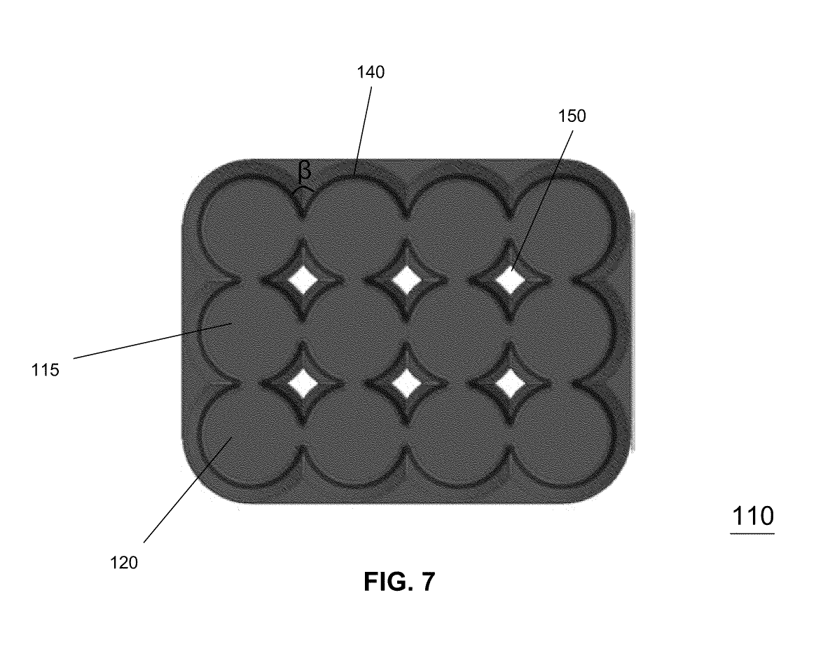

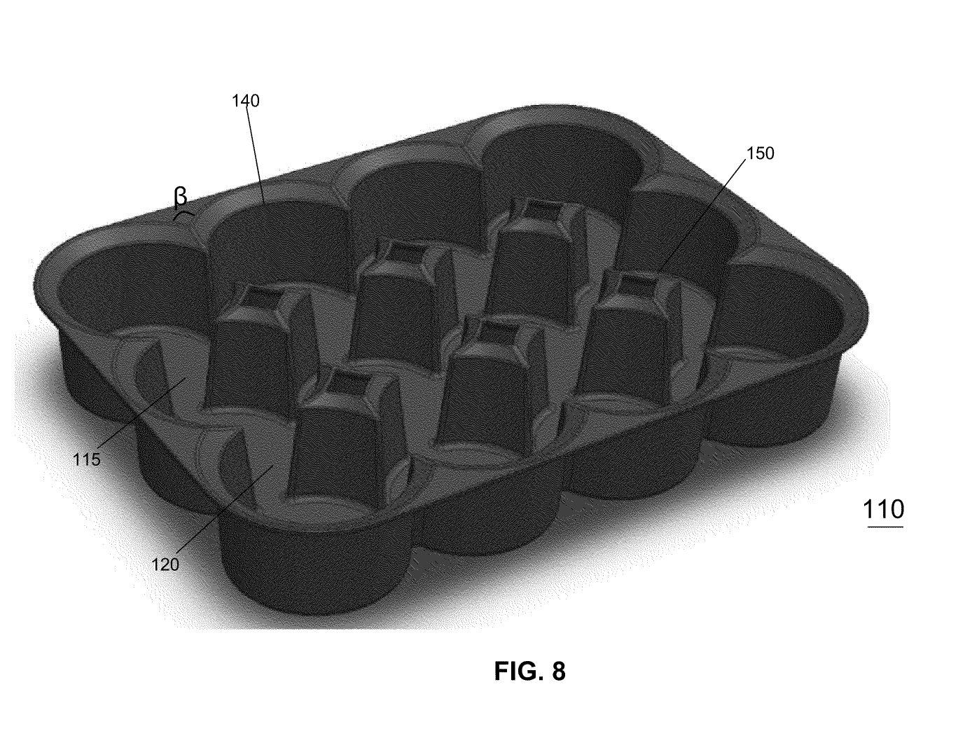

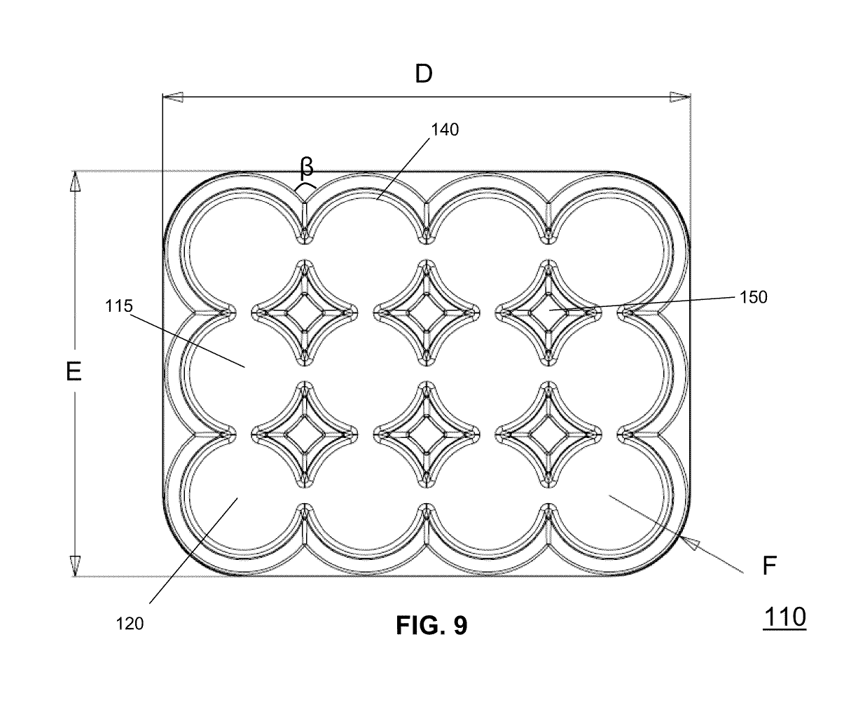

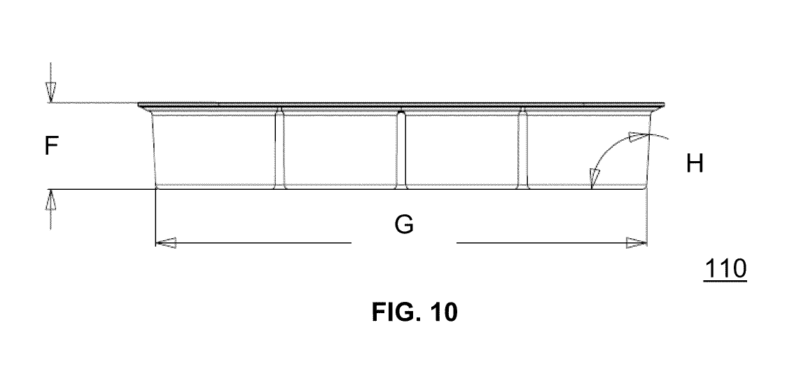

FIGS. 7-10 disclose an embodiment of the invention in which the finished pieces are generally circular in cross section. Referring to FIGS. 7-10, a baking pan 110 of an embodiment of the present invention is disclosed. Baking pan 110 comprises a single baking cavity 115 for receiving liquid batter that is formed by a bottom surface 120, a plurality of sidewalls 140, and a plurality of towers 150 rising from the bottom surface. The towers 150 may be integrally formed with the bottom surface 120 of the baking pan 110. In embodiments, the towers 150 have four sides and an open top, although different numbers of sides can be used without departing from the scope of the present invention. The towers 150 may be curved inward to form a curved edge on one or more sides of each baked good. In embodiments, the plurality of sidewalls 140 comprise a plurality of substantially arcuate sidewall segments that are each joined to adjacent sidewall segments and offset from the adjacent segments at an angle β, which is not equal to zero degrees. The towers 50 and sidewalls 40 (including sidewall segments) define a series of passages through which liquid batter can flow. Liquid batter that is poured into the baking cavity 115 can flow evenly throughout the cavity through the passages to completely and evenly fill baking cavity 115.

In addition to square and circular cross sections, the cross section of the baking compartment may generally take other shapes including elliptical, triangular, trapezoidal, or any other parallelogram. The shape of the baking compartments is not limited to shapes with a consistent cross section. For example, in embodiments, the sides of the towers and sidewalls are inclined slightly such that the finished baked goods are generally frustoconical in shape. In embodiments, the baking compartments may be formed that the finished baked goods take the shape of a character such as an animal or cartoon character.

In addition to brownies, the present invention may be used to prepare cornbread, muffins, meatloaf, stuffing or any other food product on which a crisp edge is desirable. Food that is not in a liquid form prior to baking may be firmly pressed into the baking pan of the present invention. The force of the pressing motion can then move the food product through the passages to evenly fill the baking compartments.

The baking pan of the present invention may be made from non-stick cast aluminum, although other suitable materials could be substituted including cast iron, aluminum, ceramic, glass, and the like.

Now that exemplary embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

What is claimed is:

1. A baking pan comprising:
a bottom surface;
a plurality of sidewalls comprising a plurality of sidewall segments, wherein each sidewall segment is set at an angle not equal to zero degrees to each adjacent segment;
a plurality of towers joined to said bottom surface and rising therefrom and not touching any of the sidewalls; and
a single baking cavity formed by the bottom surface, the plurality of sidewalls and the plurality of towers, wherein said towers and sidewalls define a plurality of baking compartments and a plurality of passages connecting said baking compartments.

2. The baking pan of claim 1 wherein said towers are substantially square in cross section.

3. The baking pan of claim 2 wherein said towers and sidewalls are arranged such that food or batter placed in each baking compartment is in contact with a side of said tower or a sidewall segment on each side.

4. The baking pan of claim 1 wherein said towers are substantially shaped like a parallelogram in cross section and said sidewall segments are substantially arcuate.

5. The baking pan of claim 1 wherein the towers and sidewalls are inclined such that said baking compartments are generally frustoconical in shape.

6. A method of baking a food item or baked good, comprising:
(a) providing a baking pan comprising: a bottom surface; a plurality of sidewalls comprising a plurality of sidewall segments, wherein each sidewall segment is set at an angle not equal to zero degrees to each adjacent segment; a plurality of towers joined to said bottom surface and rising therefrom and not touching any of the sidewalls; a single baking cavity formed by the bottom surface, the plurality of sidewalls and the plurality of towers, wherein said towers and sidewalls define a plurality of baking compartments and a plurality of passages connecting said baking compartments;
(b) depositing a batter or food product into said baking cavity;
(c) baking the batter or food product; and
(d) forming a food item with crisp edges.

7. The method of claim 6 wherein said towers are substantially square in cross section.

8. The method of claim 7 wherein said towers and sidewalls are arranged such that food or batter placed in each baking compartment is in contact with a side of said tower or a sidewall segment on each side.

9. The method of claim 6 wherein said towers are substantially shaped like a parallelogram in cross section and said sidewall segments are substantially arcuate.

10. The method of claim 6 wherein the towers and sidewalls are inclined such that said baking compartments are generally frustoconical in shape.
